(19) United States
(12) Patent Application Publication
(10) Pub. No.: US 2016/0350863 A1
(43) Pub. Date: Dec. 1, 2016

(54) RULE-BASED PLATFORM TO ENABLE EXCHANGE OF VOTING INTERESTS FOR SPECIFIC VOTING EVENTS

(71) Applicant: NPE Partners, G.P., San Diego, CA (US)

(72) Inventors: Christopher Williams, San Diego, CA (US); Michael Shirey, San Diego, CA (US)

(73) Assignees: NPE Partners, G.P., SAN DIEGO, CA (US); NPE Partners, G.P., SAN DIEGO, CA (US)

(21) Appl. No.: 15/166,130

(22) Filed: May 26, 2016

Related U.S. Application Data
(60) Provisional application No. 62/166,526, filed on May 26, 2015.

(51) Int. Cl. G06Q 40/06; G06F 17/30

(52) U.S. Cl. CPC G06Q 40/06; G06F 17/30312; G06Q 2230/00; G06Q 50/18

(57) ABSTRACT

A system for exchanging voting interests for voting events is described. In some embodiments, the system includes a computing device comprising at least one data processor. In accordance with various embodiments, the system can receive data over a network, determine that a voting event is scheduled, determine a company, a voting date, voting options, and voting methods associated with the voting event, determine a set of conditions for an exchange of rights to vote through the voting event, determine whether the exchange of the rights to votes through the voting event is allowed, creating a record for the voting event, provide the record for storage in a database, provide a voting interest for sale, and/or verify an eligibility of a buyer of the voting interest, based at least in part upon the set of conditions and information identifying the buyer. Related systems, methods, and articles of manufacture are also described.

### PRIORITY CLAIM

This application claims the benefit under 35 U.S.C. §119 to U.S. Provisional Patent Application Ser. No. 62/166,526 entitled “RULE-BASED PLATFORM TO ENABLE SALES OF VOTING INTERESTS FOR SPECIFIC VOTING EVENTS” and filed on May 26, 2015, which is incorporated by reference herein in its entirety

### TECHNICAL FIELD

The subject matter described herein relates to rule-based platforms for exchanging voting interests for voting events.

### BACKGROUND

Corporations and other entities sell ownership rights to the company in the form of stock. Some stocks come with voting rights, which allow the stockholder a right to vote on matters of corporate policy, composition of the members of the board of directors, and the like. Under certain circumstances, the voting rights of the stock may be sold to a broker, another shareholder, or other entity.

### SUMMARY

In one aspect, there is provided a system. The system may provide a rule-based platform for exchanging (e.g., buying and/or selling) voting interests for specific voting events. The system comprises at least one hardware data processor and at least one memory storing instructions which, when executed by the at least one hardware data processor, result in various operations. The operations comprise receiving, at a computing device comprising one or more of the at least one hardware data processor, data over a network from one or more data sources; determining, at the computing device, that a voting event is scheduled based on the received data; determining, at the computing device, a company, a voting date, voting options, and voting methods associated with the voting event; determining, at the computing device, a set of conditions for an exchange of rights to vote through the voting event, the set of conditions determined based at least in part on additional data from one or more additional data sources; determining, at the computing device, whether the exchange of the rights to votes through the voting event is allowed based on the set of conditions; creating, by the computing device, a record for the voting event when the exchange of the rights to vote is determined to be allowed, the record comprising the voting date and at least a portion of the set of conditions; providing, by the computing device, the record for storage in a database comprising a plurality of records for voting events; providing, by the computing device, a voting interest for one or more of the plurality of records for voting events for sale; and verifying, at the computing device, an eligibility of a buyer of the voting interest, based at least in part upon the set of conditions and information identifying the buyer.

In some embodiments, the above-noted aspects may further include features described herein, including one or more of the following. Monitoring, by the computing device, a data feed from a plurality of legal proceeding sources; automatically detecting, by the computing device, that a change of law regarding the exchange of the rights to vote has occurred based on the data feed; and updating, by the computing device, the set of conditions based on the change of law detected. Marking, by the computing device, the record for the voting event as ineligible when it is determined that the exchange of the rights to votes through the voting event is not allowed; displaying, via a user interface, an indication that the voting event is not eligible for sale; and prohibiting, by the computing device, access to the record for exchange. Comparing, at the computing device, the voting event against the plurality of stored records for the voting events to determine whether the voting event is new; determining, when the voting event is not new, whether a stored date for the voting event has changed based on the voting date; and updating, when the stored date has changed, the stored date to reflect the voting date. Receiving, at the computing device, one or more requests from a client device to verify whether a sale of the voting interest is valid, the one or more requests identifying the buyer and a seller of the voting interest. Receiving, at the computing device, a request from a seller to sell the voting interest for one or more of the plurality of records for voting events for sale; verifying, at the computing device, an eligibility of the seller, based at least in part upon the set of conditions and information identifying the seller; and associating, by the computing device, the seller with a record for the requested voting interest, when the eligibility of the seller is verified. The set of conditions comprises at least one of legal rules, broker rules, exchange rules, escrow rules, and underwriting rules. The plurality of records for the voting events comprise one or more table structures stored in the database. The computing device comprises a server, and wherein the one or more data sources comprise one or more content production sources.

Embodiments of the current subject matter can include systems and methods including one or more features described herein as well as articles that comprise a tangibly embodied (non-transitory) machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more embodiments of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed embodiments.

FIG. 1 illustrates a system block diagram including a rule-based platform;

FIG. 2 illustrates a block diagram of a rule-based platform;

FIG. 3 illustrates the formation and use of an investment instrument;

FIG. 4A illustrates a process for receiving and processing data related to a voting event;

FIG. 4B illustrates another process for receiving and processing data related to a voting event;

FIG. 5 illustrates a process for generating a voting event contract;

FIG. 6 illustrates a process for creating a contract with a broker or trusted seller;

FIG. 7 illustrates a process for the creation and trade of contracts;

FIG. 8 illustrates a process for selling a contract in an electronic marketplace;

FIG. 9 illustrates a process for enforcing voting restrictions;

FIG. 10 illustrates an exemplary process for utilizing a seller-stated contract entry system; and

FIG. 11 illustrates a process for generating an investment instrument.

Like reference symbols in the various drawings indicate like elements.

### DETAILED DESCRIPTION

Ascertaining the situations in which the sale of voting interests are permissible is a complicated task. In the age of electronics, persons and companies across each of the fifty states and other jurisdictions regularly conduct business with each other, and the laws in each jurisdiction are always changing. Thus, effectively tracking and monitoring eligibility of the sale of voting rights requires complicated hardware and software, including complex databases for storage and maintenance of the data. Further, enabling an electronic marketplace to buy and sell voting interests among differing entities in differing locations requires accurate and up-to-date computer systems in order to avoid potential legal issues.

In some example embodiments, there are provided systems and methods to allow owners of voting stock in corporations to sell their voting interests for specific voting events. As referred to herein, a voting interest may refer to the right to vote on a particular company matter which is up for a vote, where the right to vote may be based on ownership in the company. This right to vote may be transferred in whole or in part to another person or entity, such that the person/entity receiving the right to vote may vote on the particular matter in place of the owner (or partial owner) of the company. The systems and methods described herein may include one or more of the following: creating investment instruments; facilitating the trading and exchange of these instruments; management of inventory of these instruments; authentication of buyers and/or sellers; the management of regulatory and governmental compliance matters; the management and/or enforcement of any covenants, restrictions, agreements, representations, or other specific features associated with the investment instruments, the certification of authenticity of any information contained in or associated with the instruments, and/or other features disclosed herein.

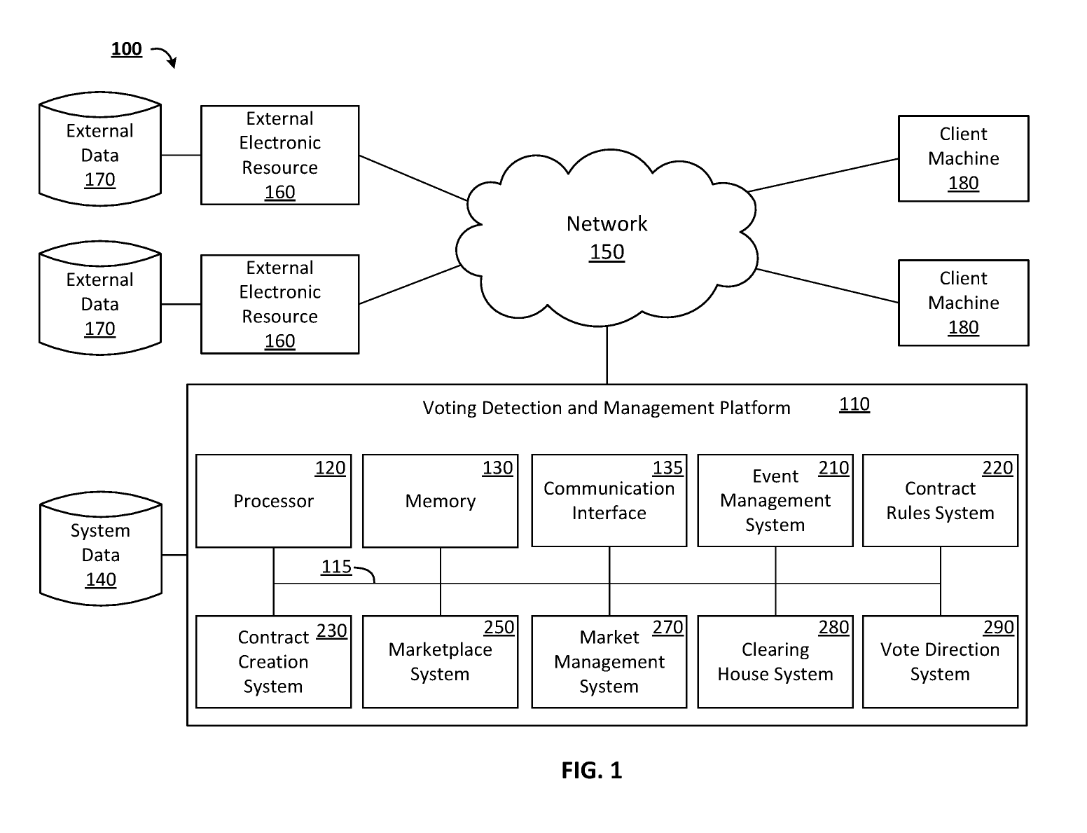

FIG. 1 depicts a system 100 including a rule-based platform 110, in accordance with some example embodiments. As illustrated, the rule-based platform 110 (labeled as voting detection and management platform) may access a network 150. The network 150 may include one or more of a local area network, a wide area network, a wireless network, the Internet, or the like. Through the connection to the network 150, the rule-based platform (also referred to herein as the platform) 110 may access one or more external electronic resource 160, and/or one or more client machine 180. In some aspects, the external electronic resources 160 can include, or have access to, websites, servers, or other sources which publish content, namely content related to corporate voting events, legal rules related to corporate voting and/or the sale of corporate voting rights, or the like. The external electronic resource 160 may be connected to external data 170 (e.g., residing in a database). Thus, through the network 150, the platform 110 may be able to access and/or retrieve data from a plurality of external sources. Although illustrated separately, in some example embodiments, one or more electronic resources 160 may be internal to the platform 110 (e.g., within the system data 140), and/or the data 170 may be input manually into the platform 110. In some aspects, the system data 140, the external electronic resources 160, and/or their associated data 170 may be referred to as “data sources.”

The client machines 180 may include personal computers, servers, mobile devices, or other computing devices capable of accessing the platform 110 through the network 150. For example, a client machine 180 may be configured to access the platform 110 through an application programming interface (API). In some aspects, client machines 180 may not be in a client-server relationship with the platform 110, and may access information within the system though other methods.

In various embodiments, the platform 110 may provide a rule-based platform to enable the sale of voting interest for voting events. As illustrated, the platform 110 can comprise a processor 120, a memory 130, a communication interface 135, and various additional systems. For example, as illustrated, the platform 110 can include one or more of an event management system 210, a contract rules system 220, a contract creation system 230, a marketplace system 250, a market management system 270, a clearinghouse system 280, and a vote direction system 290 (referred to herein collectively as the “systems 210-290”). As further illustrated, the processor 120, the memory 130, the communication interface 135, and/or the systems 210-290 may be electrically or operatively coupled to one another via a system bus 115, although other communication mediums (e.g., links, networks, connections, or the like) may be used as well.

The processor 120 (and/or co-processors or any other processing circuitry assisting or otherwise associated with the processor 120) may be in communication with the memory 130 via the system bus 115 for passing information among components of the platform 110. The memory 130 may include, for example, one or more non-transitory volatile and/or non-volatile memories. For example, the memory 130 may be an electronic storage device (e.g., a computer readable storage medium) comprising gates configured to store data (e.g., bits) that may be retrievable by a machine (e.g., a computing device like the processor 120). The memory 130 may be configured to store information, data, content, applications, instructions, or the like for enabling the platform 110 to carry out various functions in accordance with some example embodiments. For example, the memory 130 can be configured to buffer input data for processing by the processor 120. Additionally or alternatively, the memory 130 could be configured to store instructions for execution by the processor 120.

The processor 120 may be embodied in a number of different ways. For example, the processor may be embodied as one or more of various hardware processors such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 120 may include one or more processing cores configured to perform independently. A multi-core processor may enable multiprocessing within a single physical package. Additionally or alternatively, the processor 120 may include one or more processors configured in tandem via the system bus 115 to enable independent execution of instructions, pipelining and/or multithreading. In some embodiments in which the platform 110 is embodied as a server, the processor 120 may be embodied by a plurality of processors controlling operation of the server.

In some embodiments, the processor 120 may be configured to execute instructions stored in the memory 130 or otherwise accessible to the processor 120. Alternatively or additionally, the processor 120 may be configured to execute hard coded functionality. Whether configured by hardware or software methods, or by a combination thereof, the processor 120 may represent an entity (e.g., physically embodied in circuitry) capable of performing operations according to some embodiments while configured accordingly. For example, when the processor 120 is embodied as an ASIC, FPGA or the like, the processor 120 may be specifically configured hardware for conducting the operations described herein. As another example, when the processor 120 is embodied as an executor of software instructions, the instructions may specifically configure or otherwise enable the processor 120 to perform the algorithms and/or operations described herein when the instructions are executed. In some cases, the processor 120 may be a processor of a specific device (e.g., a server) configured to employ some embodiments by further configuration of the processor 120 by instructions for performing the algorithms and/or operations described herein. The processor 120 may include, among other things, a clock, an arithmetic logic unit (ALU) and logic gates configured to support operation of the processor 120.

In some aspects, the processor 120 may be responsible for encrypting and decrypting data communicated over the network 150 and/or stored within the system data 140. In some embodiments, the processor may contain specialized software and/or may have access to specialized hardware for encrypting or decrypting communications. In various embodiments, the processor 120 can have acceleration capabilities.

Meanwhile, the communication interface 135 may be a variety of mechanisms such as a device or circuitry embodied in either hardware or a combination of hardware and software that is configured to receive and/or transmit data from/to the network 150 and/or any other device or module in communication with the platform 110. In this regard, the communication interface 135 may include, for example, an antenna (or multiple antennas) and supporting hardware and/or software for enabling communications with a wired or wireless communication network. Additionally or alternatively, the communication interface 135 may include the circuitry for interacting with the antenna(s) to cause transmission of signals or to handle receipt of signals received. In order to support multiple active connections simultaneously, the communications interface 135 of some embodiments may include a plurality of cellular radios. In some environments, the communication interface 135 may support wired communication. For example, the communication interface 135 may include a communication modem and/or other hardware/software for supporting communication via cable, digital subscriber line (DSL), universal serial bus (USB) or other mechanisms.

In some example embodiments, the platform 110 may include a user interface that may, in turn, be in communication with the processor 120 to receive an indication of a user input and/or to cause provision of an audible, visual, mechanical or other output to a user. As such, the user interface may include, for example, a keyboard, a mouse, a joystick, a display, a touch screen(s), touch areas, soft keys, a microphone, a speaker, or other input/output mechanisms. Alternatively or additionally, the processor 120 may comprise user interface circuitry configured to control at least some functions of one or more user interface elements such as, for example, a speaker, ringer, microphone, display, and/or the like. The processor 120 and/or user interface circuitry of the processor 120 may be configured to control one or more functions of one or more user interface elements through computer program instructions (e.g., software and/or firmware) stored on the memory 130.

As also illustrated, the platform 110 may access system data 140 that is stored outside of the platform. For example, the system data 140 may be stored in a database, which may be stored in table format (e.g., rows and columns). The platform 110 may access the system data 140 through one or more of the processor 120, memory 130, or communications interface 135. Example data stored within the system data 140 is described in further detail below.

In various aspects, the platform 110 may comprise more or less than the illustrated components. Additionally, one or more of the illustrated components may be external to the platform 110, and/or the system data 140 may be internal to the platform (e.g., stored in the memory 130). In some embodiments, the platform 110 may provide for the monitoring of corporate stock voting events, and the automatic generation of records which may be bought or sold through client machines 180. Although much of the description herein relates to corporate voting events, similar systems may be implemented regarding other voting schemes, such as those tied to other security interests.

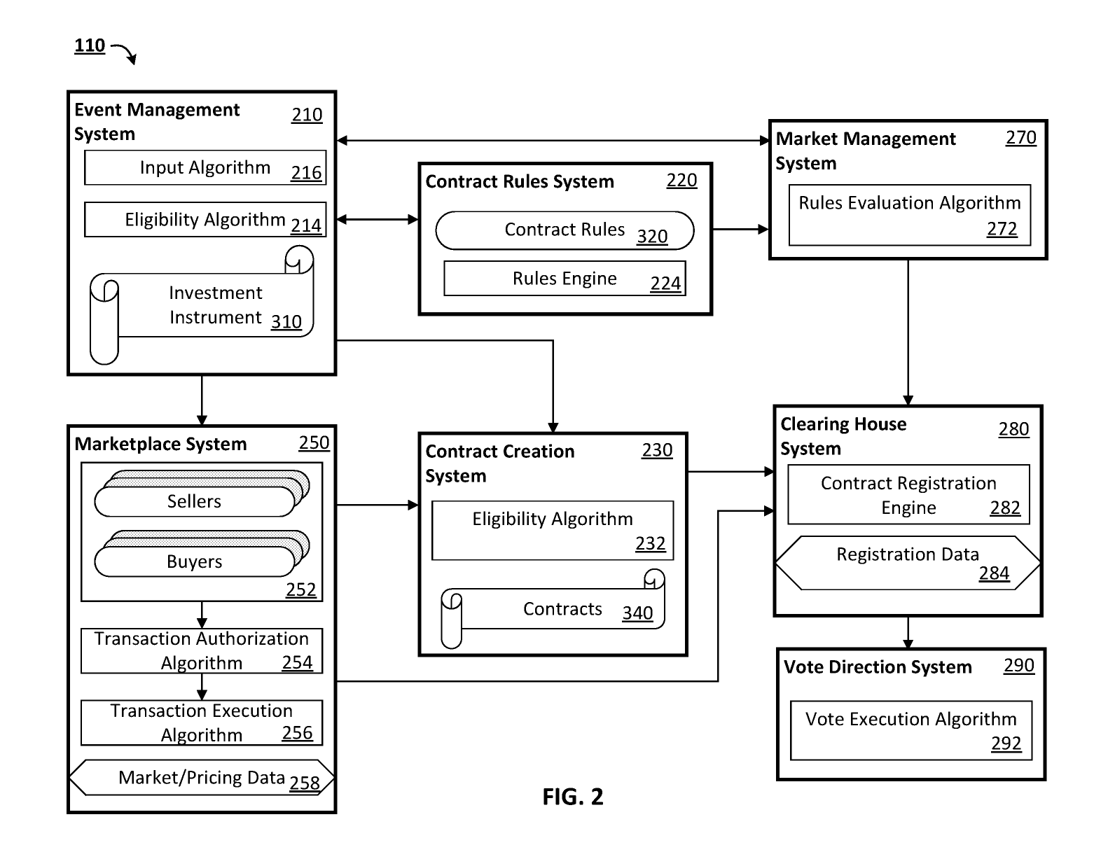

FIG. 2 depicts a block diagram of a rule-based platform 110, in accordance with some example embodiments.

The platform 110 may include the event management system 210, the contract rules system 220, the contract creation system 230, the electronic marketplace system 250, the clearinghouse and/or the vote direction system 290. The event management system 210 may be used to detect, form, create, modify, and/or otherwise manage voting events within the platform 110.

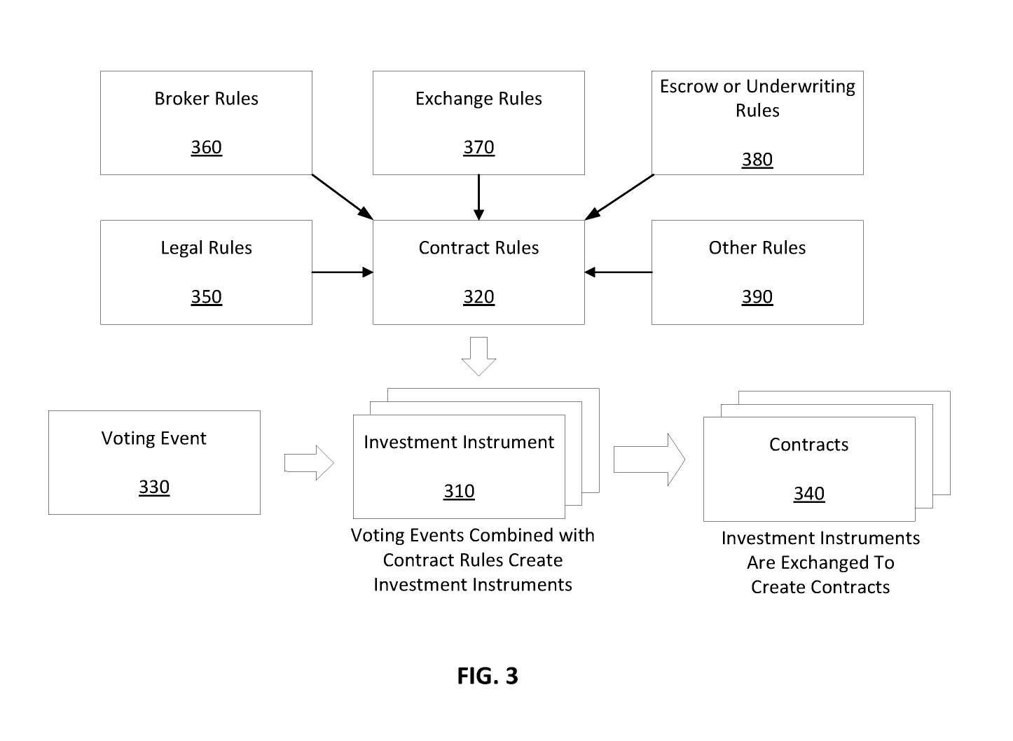

FIG. 3 depicts a formation and use of an investment instrument 310, in accordance with some embodiments. In various aspects, the formation of the investment instrument 310 may be via the event management system 210. The investment instrument 310 may be associated with and/or include contract rules 320 that indicate and/or dictate the conditions under which the investment instrument 310 may be bought, sold, exchanged, or otherwise transferred (collectively referred to herein as “exchanged” or “exchange”). As further illustrated, these contract rules 320 may be combined with information relating to a voting event 330 to form the investment instruments 310. An example format of the voting event is provided in Table 1.

TABLE 1
Voting Event Data Structure

| Data Element Name | Description |
|---|---|
| ID | Unique identification value for this record |
| Company | Reference to a company record |
| Date | The date of the vote |
| VoteType | The type of vote (e.g., board of directors, |
| | corporation action, merger approval, etc.) |
| VoteOptions | Possible vote selections (e.g., Approve/ |
| | Disapprove, Joe Smith/Bob Jones/Bill |
| | Williams, etc.) |
| VotingDeadline | Date and time votes must be received by |
| VotingMethod | Way in which votes must be cast (e.g., paper, |
| | electronic) |
| VotingInstructions | One or more records that indicate how a vote is |
| | to be cast. For electronic votes, this may |
| | indicate the location of an API, its |
| | communication protocol, and login credentials. |
| | For paper votes, this may include printable |
| | template, instructions on encoding the vote in |
| | that template, and a mailing address for the vote. |

Once formed, the investment instrument 310 may be stored in a unique format in the memory 130 and/or system data 140 of the platform 110. After an investment instrument 310 is created, one or more contracts 340 may be formed based upon one or more of the investment instruments 310. For example, in some embodiments, the investment instrument 310 may be exchanged through an online marketplace, and a contract 340 may result from the exchange.

The term “contract” rules 320 is not meant to solely reflect conditions imposed by a government or regulatory authority. For example, as illustrated, contract rules 320 may comprise legal rules 350, broker rules 360, exchange rules 370, escrow or underwriting rules 380, and other rules 390. Thus, the contract rules 320 may comprise any other conditions or rules that originate from the entities that create or interact with the investment instruments 310. The legal rules 350 may be regulations, laws, rules, or the like imposed by a government or regulatory authority. An example format of the legal rules is provided in Table 2.

TABLE 2
Legal Rule Data Structure

| Data Element Name | Description |
|---|---|
| ID | Unique identification value for this record |
| Voting Event | A reference to the voting event to which this |
| | rule applies |
| BuyerApplicabity | Location, share holdings, net worth, or other |
| | criteria that indicate one or more groups of |
| | buyers that this rule may be applicable to |
| SellerApplicability | Location, share holdings, net worth, or other |
| | criteria that indicate one or more groups of |
| | buyers that this rule may be applicable to |
| Rule | A rule which applies to this voting event, |
| | applicable buyers, and applicable sellers |

In some aspects, broker rules 360 can include provisions imposed by a broker that is facilitating an exchange. An example format of the broker rules 360 is provided in Table 3.

TABLE 3
Broker Rule Data Structure

| Data Element Name | Description |
|---|---|
| ID | Unique identification value for this record |
| RuleApplicability | Indicates if the rule applies to buyers, sellers, or |
| | both |
| Rule | A rule which applies to parties conducting |
| | business with this broker as stipulated in the |
| | RuleApplicability element |

Escrow or underwriting rules 380 can include provisions imposed by an underwriter or escrow company involved in an exchange. An example format of the escrow or underwriting rules 380 is provided in Table 4.

TABLE 4
Escrow Rule Data StructurQe

| Data Element Name | Description |
|---|---|
| ID | Unique identification value for this record |
| EscrowRequired | Indicates if escrow is required for this transaction |
| EscrowHolder | Indicates who is to be the escrow holder |
| Escrow fee | The fee to be paid to the escrow holder |

An exchange may occur in a physical or virtual marketplace where the investment instrument 310 and/or derivative contracts 340 are bought, sold, transferred, or otherwise exchanged. Thus, exchange rules 370, which can dictate the restrictions on exchanging investment instruments 310, may also be present within the contract rules 320. These exchange rules 370 may be rules implemented by an entity controlling the interface by which the investment instruments 310 are exchanged. For example, companies which provide an interface (e.g., website) through which stock may be bought and sold may also provide an interface for selling corporate voting rights. These companies may wish to implement constraints on the exchange of voting rights conducted through their interfaces, which may be accomplished through the exchange rules 370. Any other party that may be involved with the creation or execution of any investment instrument 310 or its derivative contract 340 may wish to impose rules on the sale of investment instruments, and may do so through the other rules 390. An example format of the investment instrument 310 is provided in Table 5.

TABLE 5
Investment Instrument Data Structure

| Data Element Name | Description |
|---|---|
| ID | Unique identification value for this record |
| VotingEvent | Reference to the applicable voting event and/or |
| | it's pertinent data |
| LegalRules | References to and/or applicable legal rules |
| | records |
| BrokerRules | References to and/or applicable broker rules |
| | records |
| ExchangeRules | References to and/or applicable exchange rules |
| | records |
| EscrowRules | References to and/or applicable escrow rules |
| | records |
| UnderwritingRules | References to and/or applicable underwriting |
| | rules records |

The example data structures provided herein are only one of many possible data structures which may be generated and/or used by the platform 110. For example, in various embodiments, one or more of the fields described as being part of the investment instrument 310 or the contract rules 320 may not be present, and/or additional fields may be present. In some aspects, the data relating to the voting event 330, the contract rules 320 (including separate sets of rules contained therein), the investment instruments 310, contracts 340, and/or portions thereof may be collected as and/or be stored as unstructured data. In some embodiments, the event management system 210 may be configured to receive unstructured data and convert the unstructured data into a structured data format (e.g., similar to the formats provided in Tables 1-6).

In some embodiments, the event management system 210 may seek out relevant information over the network 150 to generate at least a portion of the voting event 330, the contract rules 320 (including separate sets of rules contained therein), the investment instruments 310, contracts 340, and/or portions thereof. For example, the event management system 210 may be configured to navigate to a particular internet webpage, retrieve information indicative of a corporate voting event, process the retrieved information, and/or generate a voting event 330. Once the data is retrieved and/or processed, the data may be used to generate an investment instrument 310. Similar methods may occur for the generation of the contract rules 320, the legal rules, the broker rules 360, the exchange rules 370, the escrow or underwriting rules 380, and/or other rules 390. In some aspects, the processing and/or generation of a voting event 330 may trigger the retrieval and/or generation of contract rules 320. For example, when the event management system 210, for example, determines that a new (e.g., one not previously stored within the platform 110 and/or system data 140) corporate voting event is to occur

As noted above, the investment instrument 310 may also be associated with or include data associated with one or more voting events 330. The investment instruments 310 associated with or including the contract rule(s) 320 and/or voting event(s) 330 may be packaged into a contract 340 once sold to enable a buyer to acquire a voting right in one or more stocks. The voting right may be specific to an event or specific to a time period. For example, the voting right may be based upon a voting event determined by the platform 110, as described herein. The voting right(s) for a given stock may also be sold in other ways as well. In some aspects, a contract 340 may be bundled with a plurality of voting rights (e.g., multiple investment instruments 310) and sold as a bundle. The creation of a bundle may be performed by a system which automatically creates bundles of contracts 340, such as the event management system 210. The bundles may contain contracts 340 which are similar or different. In some aspects, the bundle may include information pertaining to the similarity or dissimilarity of the incorporated investment contracts 340. An example data structure for a bundle of contract 340 is provided in Table 6.

TABLE 6
Contract Bundle Data Structure

| Data Element Name | Description |
|---|---|
| ID | Unique identification value for this record |
| Contracts | References to the contracts contained in this |
| | bundle |
| HomogeneousContracts | Indicates whether the incorporated contracts |
| | are similar or not |
| ContractDifferences | Collection of the variances between the |
| | contracts included in the bundle. This may be |
| | references to dissimilar rules or any other |
| | reference to conflicting contract terms |
| ContractCount | Number of contracts included in this bundle |

Referring back to FIG. 2, an input algorithm 216 may collect information from a number of sources (e.g., resources 160 or data 170 of FIG. 1), and merge (or coalesce) data into voting information records. These records may be selectively stored as part of the system data 140. This data aggregation, formatting, and/or storage process may proceed from time to time, continuously, or near-continuously, as new data may become available.

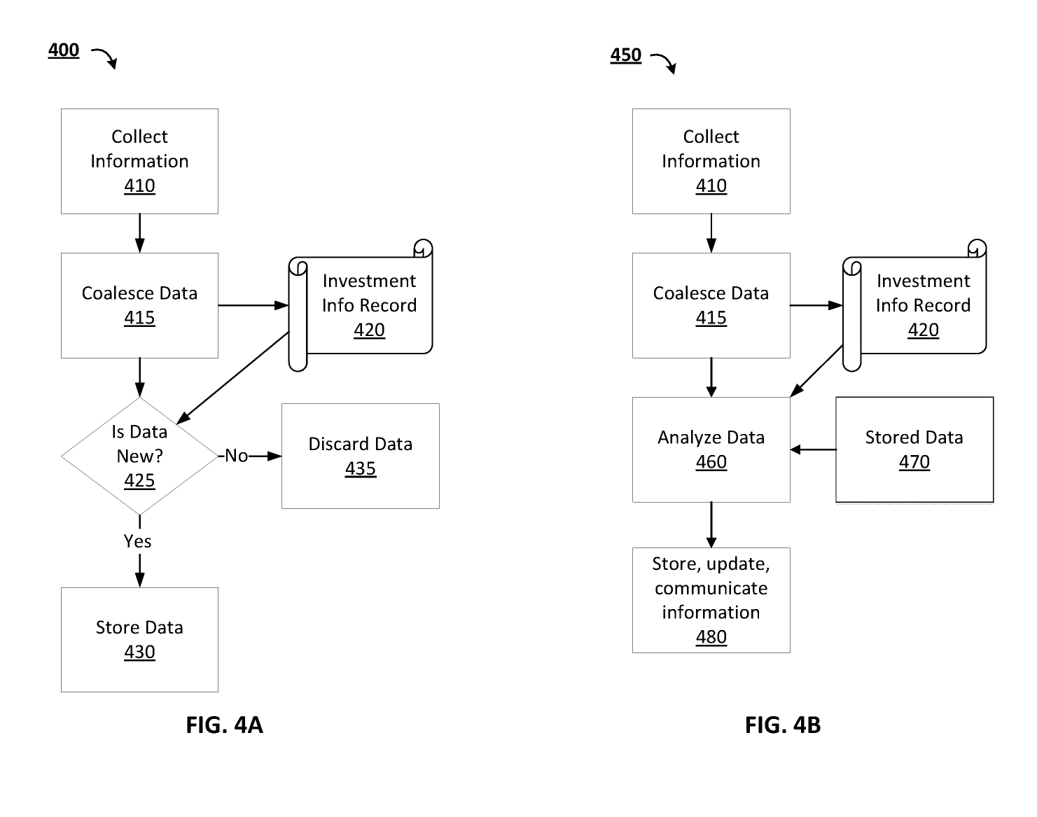

FIG. 4A illustrates an example of a process 400 for receiving and processing data related to a voting event, in accordance with some embodiments. In some embodiments, process 400 may be implemented by the event management system 210.

At 410 the event management system 210, for example, may collect information. To collect information, the system may couple to various data sources that may be public or private. For example the event management system 210 (e.g., via the input algorithm 216) may monitor external resources 160 to determine whether information regarding a corporate voting event is published, posted, or otherwise provided. If so, the input algorithm 216 may utilize this information to form an investment instrument 310. These resources 160 may include repositories of information that may be related to publicly traded companies or corporate voting events. For example, the resources 160 may include government or regulatory filings, press releases, news feeds, company websites, proxy voting company databases, and other sources.

Additionally or alternatively, the event management system 210 may be able to receive information directly via human, mechanical, or other form of direct input. Data provided to the system may come in any number of formats, including binary formats or other formats that are machine readable, as structured data provided as data records, or as free text or other unstructured data that the system would interpret and process as part of the coalescence of the data received. As noted herein, the event management system 210 may monitor external resources 160 to determine whether information is published, posted, or otherwise provided. The event management system 210 may be made aware of new or updated data by the data source, or may poll or otherwise automatically monitor data sources for new or updated data. The event management system 210 may also know to look for certain data based on a calendar, for example after SEC meetings, Federal Reserve meetings, and/or the like.

At 415, the event management system 210, for example, may coalesce or otherwise combine the received data to form a record. To combine data, the event management system 210 may aggregate information from the resources 160 to build a collection of records of voting information. For example, as illustrated, the information may be used to form an investment information record 420. Each individual investment info record 420 may include one or more of the date of a vote, the company that the vote is applicable to, a description of the vote, the choices available to the voter, voting eligibility information, and/or any other information related to the company or the method in which voting occurs, such as how votes are to be submitted, tabulated, or otherwise counted.

To store data, after the information has been collected and records of each vote are created, at 415 the event management system 210, for example, may check with a storage medium (e.g., memory 130 or system data 140) to determine if the data is new. For example, the event management system 210 may determine whether an investment information record 420 generated already exists in the system data 140. If the record 420 is new, the event management system 210 may store the data/records in a database, flat file, computer RAM, or the like at 430. If the data is not new, the system may discard, ignore, or otherwise mark the data/record as not being unique at 435.

Some embodiments may perform analysis of all or some of the data previously stored in conjunction with the investment information record 420 as to determine the accuracy, relevance, or significance of any direct, derived, or implied information that may be stored or made available by the system at any time.

FIG. 4B illustrates another example of a process 450 for receiving and processing data related to a voting event, in accordance with some embodiments.

At 460, the event management system 210 may analyze the new investment information record 420 (or may periodically analyze stored data) to determine whether system data 140 should be updated. The system 110 may have for example three investment information records 420 stored in the system data 140. A new investment information record 420 may be compared against stored data 470, which may represent historical data. The event management system 210 may determine that if two of the pieces of information are somehow equal and in conflict with the third piece of information, the third piece of information is likely to be inaccurate. In this instance, the new investment information record 420 may be discarded, ignored, or the like. However, if the new investment information record 420 is determined to be new compared to the stored data 470 or determined to include an update to the stored data 470, then at 480, the event management system 210 may store, update, or otherwise communicate information regarding the stored data 470 or the new investment information record 420. Other embodiments may utilize any number of techniques for determining accuracy and/or newness of stored data 140 as compared to a newly created investment information record 420, for example.

For example, if the event management system 210 determines (e.g., at 460) that a vote has had its date changed, the event management system 210 may take additional action to notify other systems of such a change at 480. In some aspects, the event management system 210 may provide the information regarding a change to the market management system 270, which may handle the change, as described further below. Other types of analytics that may be performed on incoming or historical information may include determination of reliability of data. In some embodiments, two pieces of conflicting information may have been captured from two different sources. One of these sources may have been deemed to be highly reliable (for example, an official SEC filing) and the other source may have been deemed to be less reliable (for example, a news website). The system may decide to ignore some or all of the information from the less reliable source in favor of information from the more reliable source in this instance. This sort of analysis can be extended to resolve conflicts of information across any number of sources in lieu of the majority-wins decision making process described herein. The relevance of information may also be analyzed through this or a similar process. For example, information which has been collected that does not pertain to any voting event that may legally be sold may be determined by an algorithm similar to the eligibility algorithm 214 described herein.

As illustrated in FIG. 2, the event manager 210 may also include an eligibility algorithm 214. The eligibility algorithm 214 may assess whether stock associated with each voting event (e.g., a corporate governance action) is eligible to allow the separation of its voting interests and economic interests. The eligibility algorithm 214 may use information pertaining to the local, state, and federal laws and regulations that are applicable to the company, shareholder, and vote in question to assess whether it is legal for one or more classes of shareholder to sell their voting interests.

As illustrated, the contract rules system 220 may comprise a rules engine 224. The eligibility algorithm 214 at event management system 210 may access rules, regulations, or the like defined through the contract rules system 220 (e.g., within the contract rules 320) to determine the legality of vote selling and any restrictions, regulations, or other rules that may be applicable. For example, when a voting event involves a vote for a board member for a company located (e.g., incorporated and/or conducting business) in Delaware, the contract rules system 220 may determine that votes can be sold only by shareholders residing outside of Delaware, and/or that shareholders that live in New York are required to file a notice with the State of New York in order to sell their voting interests. These rules may be stored within the contract rules 320 as described herein. Further, if the investment instrument 310 was created by or otherwise associated with Investment Brokerage A, then a contract rule 320 may be in place that stipulates that Investment Brokerage A must hold any shares pertinent to the transaction in escrow and will be due a specified fee for doing so.

The contract rules system 220 may create a set of contract rules 320 related specifically to each voting event such that individual investment eligibility decisions can be made later. Using the example above for the vote for a board member for a company located in Delaware, the system may create and store contract rules 320, an example of which is depicted at Table 7 below.

TABLE 7
Contract Rule

Shareholders in Delaware cannot sell voting interests;
Investors in Delaware cannot buy voting interests;
Shareholders in New York must file form REG-A3 with the State
of New York when selling votes;
Investors in California cannot buy voting interests;
Investors outside of the United States cannot buy voting interests;
Shareholders outside of the United States must file form USR-3
with the U.S. Security and Exchange Commission (“SEC”) when
selling votes;
Investors controlling more than 5% of votes must file form USA-6
with the SEC;
Shares whose voting interests have been pledged are to be held in
escrow until the voting deadline by Investment Brokerage A;
and/or
Investment Brokerage A is due $0.001 per share held in escrow as
payment for escrow services.

This comprehensive set of contract rules 320 may contain one or more rules that are relevant to a specific investor. For example, a set of contract rules 320 associated with an investment instrument 310 may contain one or more rules that pertain to US citizens and different rules that pertain to US citizens living in California, such that both rules apply to an investor who is both a US citizen and living in California. A hierarchy of applicability may also be associated with various rules such that if there is a conflict between two or more rules, the conflict can be resolved. For example, a rule from the SEC may indicate that the seller must have a net worth in excess of $1 M, but a California State Law may indicate that the net worth requirement should be $100K. In this case, the SEC rule might be given a higher position in the rule hierarchy, and would be the rule that is applied. In other embodiments, more complicated algorithms may be used to resolve these conflicts, such as algorithms that will apply the most conservative or restrictive rule.

The contract rules 320 may be created and stored in any format, including machine-readable formats such as binary, HTML, SQL, XML, or the like, and/or in an encoded form. These contract rules 320 may cover a number of subjects such as the aforementioned geographic restrictions, financial suitability restrictions similar to those defined by SEC Regulation D, specific stock ownership dates and durations, or the like. Any designations of particular forms, regulations, or the like noted herein are purely demonstrative and are not intended to limit the scope of the invention as defined by the claims.

The contract rules system 220 may also allow rules to be updated from time to time. Any such updates may be performed by changes to software (e.g., in the memory 130), updates to databases (e.g., in the system data 140), or the like. For example, the platform 110 may include automatic functionality where, for example, the contract rules system 220 is able to monitor the outcomes of legal proceedings and update its rules based on rulings in federal courts, monitor reference interest rates such as the LIBOR and update any stipulated rates accordingly, or the like. This monitoring may be achieved automatically as a function of an event management system similar to the system described with respect to FIG. 4A or 4B. Where applicable, rule changes which impact outstanding investment instruments 310 may be handled by the market management system 270 described further below.

The contract rules system 220 may be able to accommodate multiple variations of similar contract rules 320 for investment instruments created by a number of sources. The contract rules system 220 may be able to compare the rules associated with various contracts that might have the same voting event to identify differences between multiple variations of contracts pertaining to a specific voting event. The sources can include brokerages, exchanges, individuals, or other entities. For example, Brokerage A and Brokerage B may have each issued financial instruments representing the same voting event, but other terms of the instruments may be different, such as a different mandated escrow holder or fees. In this instance, different investment instruments 310 may be created with different associated contract rules 320. In this example, the key data element to which variations are derived may be the specific voting event, but other key data elements may be used for other purposes.

When the contract rules system 220 determines that there is no conceivable situation in which the sale of voting interests for a particular vote may be legal or otherwise permissible, a voting information record (e.g., for a given investment instrument 310) may be marked as ineligible. Thus, the marketplace system 250, for example, may determine that the investment instrument 310 should not be sold or offered for sale.

Instrument Creation

When the contract rules system 220 determines that one or more instances exist in which the voting rights of the share may be bought, sold, traded, transferred, or otherwise exchanged between parties, an investment instrument 310 may be created (e.g., as shown at FIG. 3). This investment instrument 310 may be used to form a contract wherein, for example, a seller pledges to place one vote per share held by (or otherwise controlled by) the seller for one or more specific voting events as directed by a buyer. The investment instrument 310 may also contain requirements wherein, for example, a third party is identified as an entity which will actually place the vote on behalf of the seller at the direction of the buyer. Additionally or alternatively, the investment instrument 310 may also contain requirements related to any or all rules and responsibilities, covenants, representations, and so forth, that may have been determined by the contract rules system 220. The investment instrument 310 may also contain a requirement related to the sale or transfer of the shares by the seller, the transfer or sale of any contracts created from the investment instrument 310, or any other requirement as may be required to facilitate a transaction.

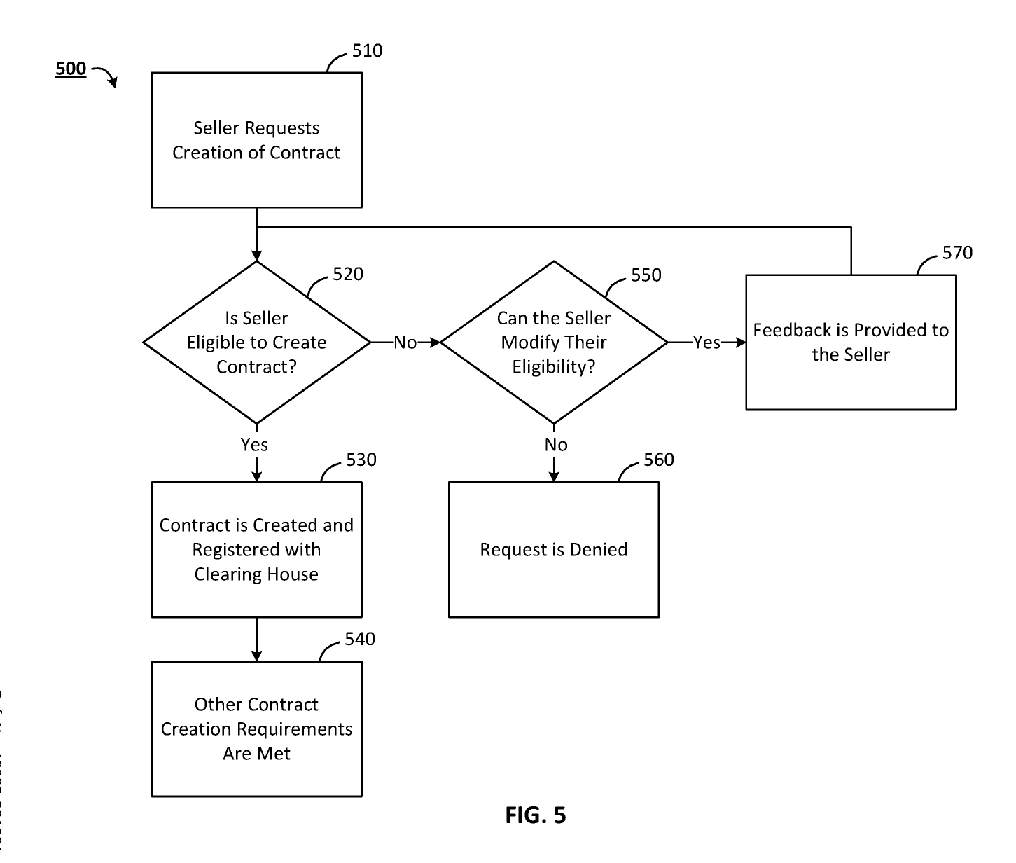

FIG. 5 illustrates a process 500 for generating a voting event contract, in accordance with some embodiments. Process 500 may be implemented in whole or in part by the contract creation system 230 and/or an eligibility algorithm 232 of the contract creation system 230. Contracts may be created by individuals or organizations, brokers, dealers, exchanges where these contracts are traded, or by any number of other entities. For example, an organization which sells stock may also sell voting interests, and the sale of the voting interests may create contracts. The platform 110 may not just exchange investment instrument(s) 310, as the contract(s) derived from the investment instrument(s) 310 may also be traded, sold, bought, and/or the like via the platform 110.

In some aspects, the contract creation system 230 may create or utilize investment instruments 310 on demand (e.g., at the request of a seller, a buyer, or any other entity) according to the process 500.

At 510 the contract creation system 230, for example, may receive a request from a seller for the creation of a contract. This request may be in response to the seller attempting to sell their voting rights for a specific voting event through the marketplace system 250, for example. Thereafter, at 520, the contract creation system 230, for example, may assess the eligibility of the seller to create the contract. To that end, the eligibility algorithm 232 may consume as input, information pertaining to the seller that may be relevant, including information such as the seller's location, citizenship, number of shares of stock owned for a company holding the voting event, and/or other information. As above, a seller may be an individual, brokerage, or some other entity. The relevant information about the seller may be provided by an authorized broker, be determined from electronic sources, or may be provided by the seller via a questionnaire or other way or mechanism of direct information gathering.

In some embodiments, the platform 110 may provide for the registration of users which may exchange or otherwise be involved in the exchange of voting interests. As part of, or subsequent to, the registration process, a user may input at least some of the relevant information about themselves discussed herein. This information may be verified by the system 110 based on the inputs provided by the user and/or through external resources 160. For example, consistency checks may be performed on the information and/or algorithms may be used which accept certifications made by the user (e.g., made under penalty of perjury). In some embodiments, the verification of a user's information may be provided by an operator of the system 110, which may be based on the operator independently verifying the information outside of the context of the system 110. As part of 520, this information may be compared with the contract rules 320 created by the contract rules system 220 and associated with the particular investment instrument 310 which the seller is attempting to sell in order to determine the eligibility of the seller to enter in to this type of agreement.

If at 520 it is determined that the seller is not eligible to enter in to this type of agreement, then the process 500 may proceed to 550 where it is determined whether the seller may modify their eligibility requirements. For example, the reasons why the seller was determined to be ineligible may potentially be correctable by the seller. For example, the eligibility algorithm 232 may identify which contract rule(s) 320 the seller does not meet, and may determine whether the reasons why the identified contract rule(s) 320 are not met is correctable. For example, if the contract rule 320 which the seller does not meet is based on the seller's lack of credentials, then an associated contract rule 320 may indicate that the seller may fill out a particular form to obtain the credential. An indication of whether each contract rule 320 is correctable may be stored as part of the contract rules 320. When it is determined that the seller may become eligible at 550, the process 500 may proceed to 570 where the seller is informed of corrective actions that the seller may take to become eligible to enter in to the contract. These corrective actions may be anything permissible by the contract rules 320 (e.g., actions permissible by law) and may involve, for example, the seller providing additional information about themselves, the registration of the seller with various government agencies, or other activities. In some aspects, the system 110 may provide for taking corrective action to the seller through a user interface. Once the seller completes the corrective action, process 500 may return to block 520 where eligibility is assessed. If it is determined at 550 that the seller cannot modify their eligibility, then the process 500 may proceed to 560 where the seller's request to enter into the contract is denied.

Contract Creation

If the seller is determined to be eligible to create a contract at 520, the process 500 may proceed to 530 where the contract creation system 230 may create the contract. Additionally, the contract creation system 230 may provide the contract to the clearinghouse system 280, which may register the contract with an appropriate clearinghouse or otherwise notify an appropriate entity of the existence of the contract as necessary. After the contract is created and/or registered, the process 500 may proceed to 540 where the contract creation system 230 may perform any additional functions, such as those identified as necessary by the contract rules system 230 for this specific seller, or otherwise required to create, sell, or facilitate the trading of the newly created contract. For example, if the contract creation system 230 determines that the seller is required to disclose their creation of the contract to a regulatory body, the contract creation system 230 may automatically notify the regulatory body and/or may notify the seller, the seller's broker, or another interested party to which the seller may be required to provide such disclosures.

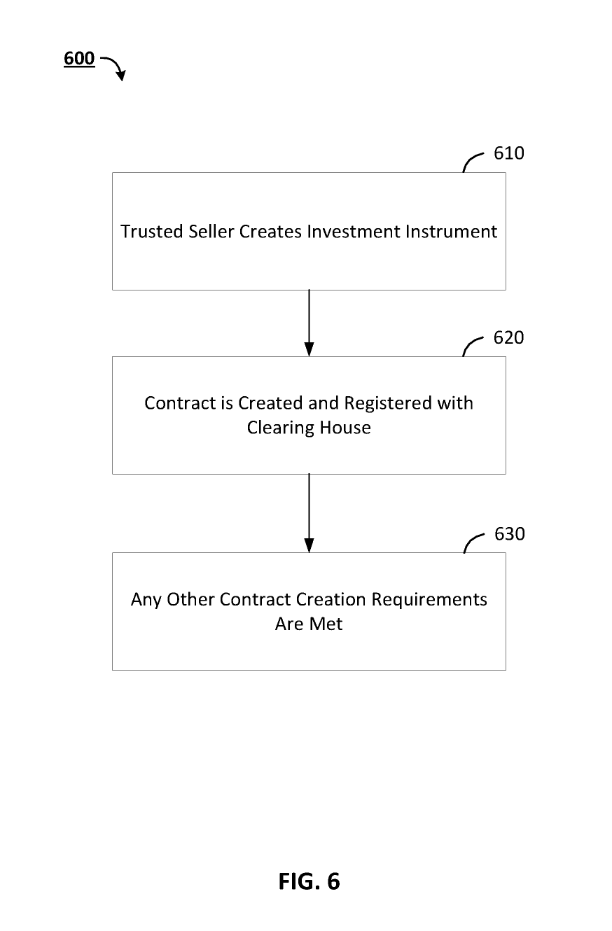

FIG. 6 depicts a process 600 for creating a contract with a broker or trusted seller, in accordance with some embodiments. Process 600 may be a truncated version of process 500 of FIG. 5, as the seller attempting to create a contract may already be trusted (e.g., licensed and/or credentialed). Process 600 may start at 610 where the event management system 210 and/or the contract creation engine 230, for example, may be used by a broker or trusted seller to create and/or use an investment instrument 310. Process 600 may then proceed to 620 where the contract creation engine 230 and/or the clearinghouse engine 280, for example, may create and/or register the contract, when appropriate. Next, the process 600 may proceed to 630 where the contract creation engine, for example, may perform any other requirements for the contract, such as those dictated by the associated contract rules 320 for the investment instrument 310. Process 600 may be utilized in an exchange where the eligibility to create contracts is determined by the broker or trusted seller. In some aspects, eligibility may be made as representation from the broker or trusted seller.

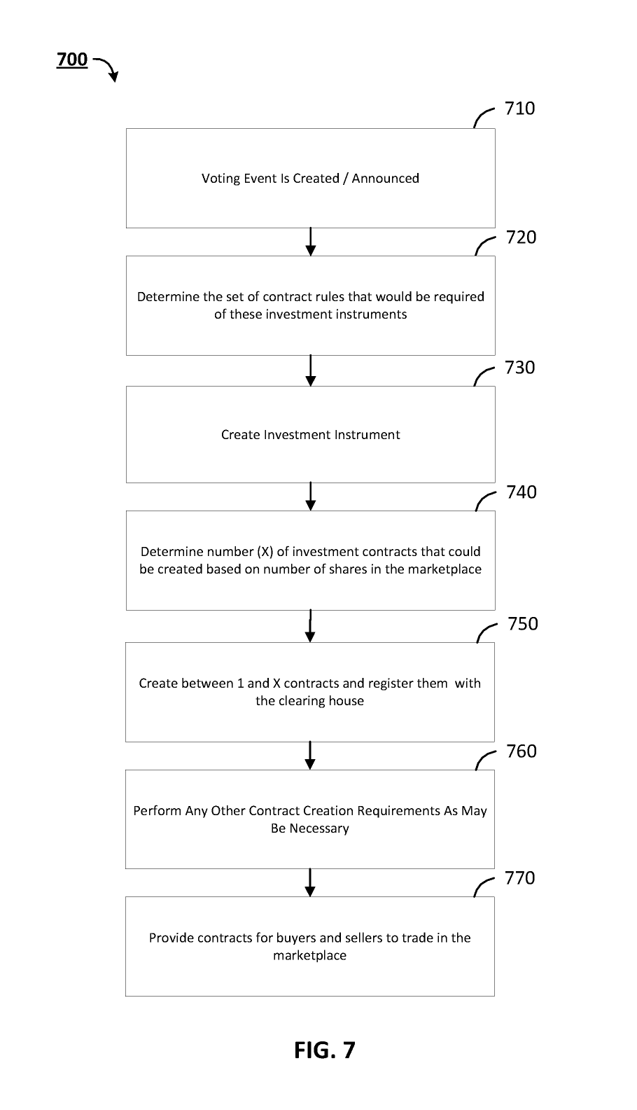

FIG. 7 depicts a process 700 for the creation and trade of contracts, in accordance with some embodiments. For example, the marketplace system 250 may be used by users to trade voting rights. Pursuant to method 700, a central party such as a broker or exchange may use the platform 110 to create the investment instruments 310, with or without the request of any buyer or seller. These investment instruments 310 may be held as inventory to be bought, sold, and otherwise traded.

Process 700 may begin at 710 where the event management system 210, for example, may determine that a voting event is created or announced. Next, at 720 the contract rules engine 220, for example, may determine the set of contract rules 320 that would be required for the exchange of voting rights for the voting event. Next, at 730, the event management system 210, for example, may create an investment instrument 310 for the voting event, based on the determined contract rules 320. When a voting event is created by a company, or at any other time after a voting event is created, the contract creation system 230 may consult with the contract rules system 220 in order to create the contracts 340, but as there is no buyer or seller identified yet, the system may not utilize an eligibility algorithm until such time as a seller may be available. With the contract rules 320 defined, an investment instrument 310 can be created, from which the contracts 340 may be derived. Process 700 may continue at 740, where the marketplace system 250, for example, may determine the number of votes that may be sold, which can be the number of shares of a particular stock that are issued and outstanding. This information may be stored in the market/pricing data 258 of the marketplace system 250. Next, at 750, the contract creation system 230, for example, may then create a number of contracts, not to exceed the number of votes that may be sold. Thereafter, at 760, the contract creation system 230 and/or the clearinghouse system 280, for example, may perform any other actions as necessary. Next, at 770 the marketplace system 250, for example, may offer the contracts for exchange.

In some embodiments, if necessary, upon the creation of a contract 340, the clearinghouse system 280 may handle placing the underlying shares into an escrow account or placing some other encumbrance upon the shares until the vote has been completed. These encumbrances may be stored in the registration data 284 of the clearinghouse system 280. These requirements may be dictated at least in part by the contract rules 320 pertaining to the investment instrument 310 from which the contract was derived. These encumbrances may be enforced by the clearinghouse system 280 that captures registration of contracts as they are created, and/or they may be tracked or enforced by other authorized third parties, such as an individual's broker authorized to conduct transactions on the exchange. For example, if a shareholder wishes to sell voting rights for a particular vote for one hundred shares, the contract creation system 230 may, upon validation that the seller is eligible to do so, create a contract for one hundred shares that the seller may then offer for sale, trade, or otherwise exchange. The contract creation system 230 may determine that the seller is required to notify the SEC of the contract creation, so the clearinghouse system 280, for example, automatically notifies the SEC via electronic or other ways, such as printing and mailing paperwork.

Once a contract is created and registered, it may then be listed for sale via the marketplace 250 system. In some aspects, registered may mean any number of actions wherein the existence of the contract is determined to be valid such as declaring the contract with a third party that may keep track of such contracts and their underlying shares. The sales may be facilitated privately, through a broker, or through an exchange which utilizes the platform 110, over the network 150, for example. The marketplace system 250 may facilitate transactions between two or more parties. The marketplace system 250 may have features such as an ability to match buyers and sellers, an ability for buyers and sellers to trade with complex rules such as limit prices, and/or an ability for market participants and other parties to receive current pricing information. The interactions conducted through the marketplace system 250 may be regulated by government or private regulators, but the marketplace system 250 may also be unregulated, similar to online marketplaces where other goods and services are bought, sold, exchanged, or otherwise traded. Regardless of how the transaction is facilitated, the eligibility of both the buyer and seller may be assessed with respect to the contract rules 320 associated with the investment instrument 310 from which the contract 340 was derived.

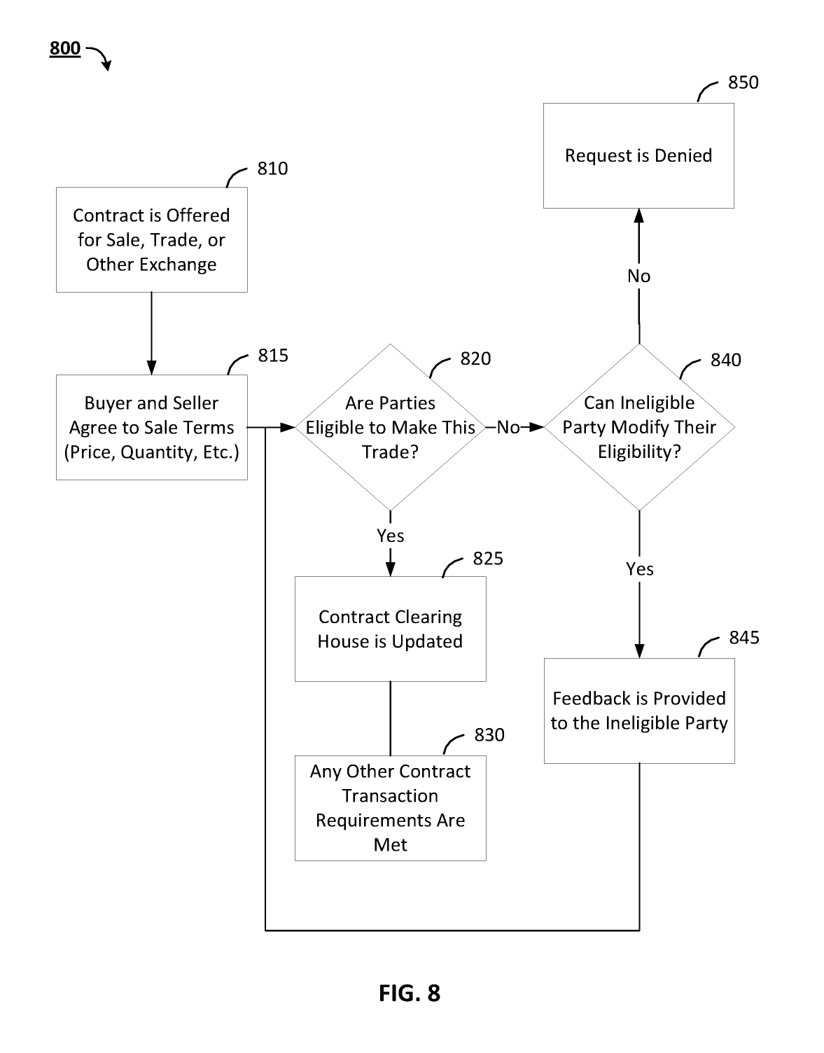

FIG. 8 illustrates a process 800 for selling a contract in an electronic marketplace, in accordance with some embodiments. As illustrated in FIG. 2, the marketplace system 250 may include buyer and seller information 252, a transaction authorization algorithm 254, a transaction execution algorithm 256, and/or market/pricing data 258. The buyer and seller information 252 may be based upon information provided by buyers and sellers themselves (e.g., upon registration), publicly available information about the buyers and sellers (e.g., through external resources 160), and/or information provided by other users other platform 110. The transaction authorization algorithm 254 may determine the eligibility of the buyer and seller to participate in any specific transaction. Additionally or alternatively, the transaction authorization algorithm 254 may be able to assess the eligibility of a buyer or seller to participate in the market for any potential transaction related to any voting event. For a specific transaction, the transaction authorization algorithm 254 may collect information pertaining to the buying and selling parties, as well as any other information that may be necessary to make an eligibility decision. The manner in which this information is collected can be similar to the way in which information is gathered by the eligibility algorithm 232 of the contract creation system 230. This information may be used to assess the rules and regulations that were determined by the contract rules system 220 associated with the underlying investment instrument 310, as they may pertain to either the buyer, the seller, or both. As illustrated in FIG. 8, the process 800 may begin at 810 where the market system 250, for example, offers a contract for sale. Next, at 820 through the marketplace system 250, for example, a buyer and seller may agree to sales terms for the contract. Thereafter, at 830 the transaction authorization algorithm 254, for example, may evaluate one or both of the buyer and seller against the rules that were determined by the contract rules system to determine whether the buyer and seller are eligible under the contract rules 320. Similar to the eligibility algorithm in the contract creation system 230, if one or both of the buyer and seller are determined to be ineligible, process 800 may proceed to 840 where the transaction authorization algorithm 254, for example, may determine whether corrective action may be taken, and if so, process may proceed to 845 where the transaction authorization algorithm 254, for example, may provide notification to either party of corrective actions that may be required to make that party eligible to engage in the transaction. Once the corrective actions are taken, the process 800 may return to 820. If no corrective action may be taken at 840, then the process 800 may proceed to 850 where the transaction is denied.

The transaction authorization algorithm 254 may also provide general assessments for a given buyer or seller. These assessments will evaluate the buyer or seller in general as it may relate to all available investment instruments 310. For example, there may be a state law which prohibits residents of Florida from participating the sale of voting interests. Thus, the authorization algorithm 254 will evaluate a buyer or seller from Florida as therefore being ineligible to participate in any transactions. In some instances, it may be the case that one or more parties to the transaction may incur some sort of fee or penalty for completing the transaction, even though the transaction has been determined to otherwise be eligible for execution. This may, for example, include instances where one party would control more than 5% of the company's voting rights and the buyer would then have to register with the SEC and pay a nominal fee. In such cases, the transaction authorization algorithm 254 may inform the parties of this occurrence, and ask for confirmation and acceptance of the consequences of consummating the transaction.

Once a transaction has been authorized, and the involved parties have decided to execute the transaction, the process 800 may proceed from 820 to 825 where the transaction execution algorithm 256, for example, may update the appropriate registration clearinghouse(s) with the transaction details through the clearinghouse system 280, for example. These details can include one or more of the buyer's relevant information, the seller's relevant information, contract identifiers, information pertaining to the company and the voting event, and so forth. After the clearinghouse has been updated, the process may then proceed to 830 where the transaction execution algorithm 256, for example, may perform any other actions that may be required as may be related to any contract rules 320 set forth by the contract rules system 220. For example, the transaction execution algorithm may determine, based on its assessment of the contract rules 320 and information it has received/determined about the buyer, that a form must be filed with the SEC. The transaction execution algorithm 256 may, in this example, complete the action electronically or notify the buyer that the form must be filed with the SEC.

The registration data 284 of the clearinghouse system 280 may also be a source of data for the marketplace system 250 or other components of the platform. The clearinghouse system 280 may be able to provide information such as the number of shares encumbered for a particular voting event, and other relevant information. This data may have one or more uses. For example, one use may be in the valuation of any encumbered share since it may very well be the case that shares may be sold or otherwise transferred independently from any voting rights they may have had prior to the sale of those voting rights and shares that do not include voting rights have a value different than shares that do include voting rights. The term clearinghouse used herein may refer to any number of entities, computer systems, or other organizations or compositions of matter that might be identified as a source of truth related to specific encumbrances and voting directions that may be associated with specific shares of stock.

The vote direction system 290 may maintain the way in which votes are to be cast, as directed by the owner (e.g., the buyer) of any outstanding contracts. These voting instructions can be for any possible selections that may be available to the voter, including, where possible, the option to “write in” or specify freely any value for their vote. The vote direction system 290 may allow for the owner to change this designation at any feasible time prior to the actual corporate vote or any other deadlines that may exist (e.g., through the contract rules 320). The vote direction system 290 may provide for an authorization mechanism for the vote owners to authenticate themselves prior to making any voting directions. The vote direction system 290 may also remove any voting directives associated with a contract upon a change of ownership of that contract.

The voting execution algorithm 292 at vote direction system 290 may provide the functionality described above and/or additional functionality.

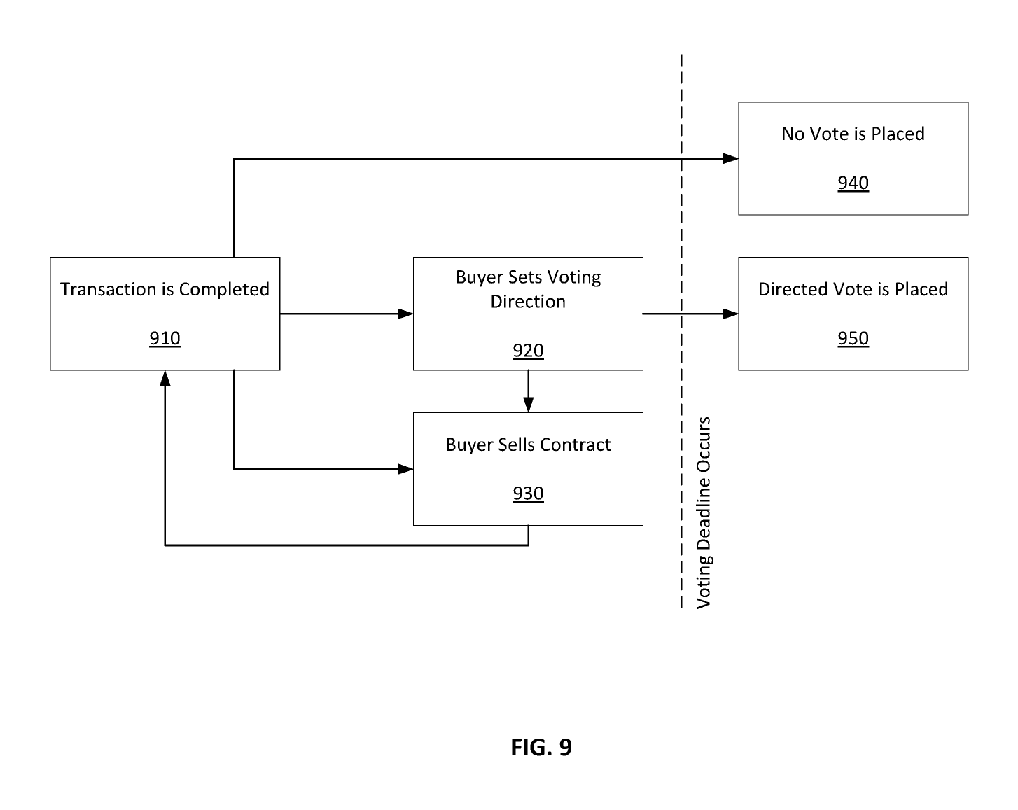

FIG. 9 depicts a process 900 for enforcing voting restrictions, in accordance with some embodiments. Process 900 may be implemented at least in part by one or more of the components of the platform 110 described herein, such as the vote detection system 290, for example. When a contract is transferred at 910, prior to the voting deadline stipulated by the investment instrument 310, the new owner may provide direction as to how the underlying votes are to be cast at 920. The owner may modify this direction at any time prior to the voting deadline. If the owner sells the contract prior to the voting deadline at 930, then any voting directions previously provided by the owner may disregarded. At such time as a vote may occur, the voting execution algorithm 292 may assess which shares are to be voted and the manner to which they are to be voted based upon a plurality of outstanding contracts. This voting execution algorithm 292 may review all contracts that have been registered and place the requisite votes as directed by the owners of each contract at 950. Votes may be placed electronically or via any other method. As may be required or otherwise determined by the contract rules system 220, the voting execution algorithm 292 may handle the filing of any required documentation, provide any required notifications, or perform any other actions as may be required to complete the act of voting. In such event as voting direction had not been provided by the current owner for a particular contract, no votes will be placed for that contract at 940. This may be in the form of a vote to abstain or a vote to a default selection, or to proxy the vote, as may be defined in the specific contract rules 320. Other embodiments may exist wherein votes are placed according to other contract rules 320 in this instance.

Referring back to FIG. 2, as new information is received by the market management system 270, the rules evaluation algorithm 272 may determine which, if any, course(s) of action should be taken. For example, the rules evaluation algorithm 272 may evaluate a set of rules that govern how it should respond to all events, events of a specific class (such as date changes or vote cancelations), or events affecting a specific instrument (e.g., a contract 340). These rules may be dynamic and the system may be able to change its behavior to reflect changes in rules. The actions taken by the rules evaluation algorithm 272 may be as simple as providing notifications to owners of contracts 340, but may additionally or alternatively involve actions such as canceling contracts 340 due to cancelations of voting events. These rules may be specified within the contract rules 320 and/or within the market management system 270, and may be changed by any manual or automatic process, which may include human intervention or other methods.

The platform 110, in addition to embodiment and use as a complete system, or as one or more piecemeal parts of another system, may also be embodied as system that facilitates the creation of contracts with varying sets of features.

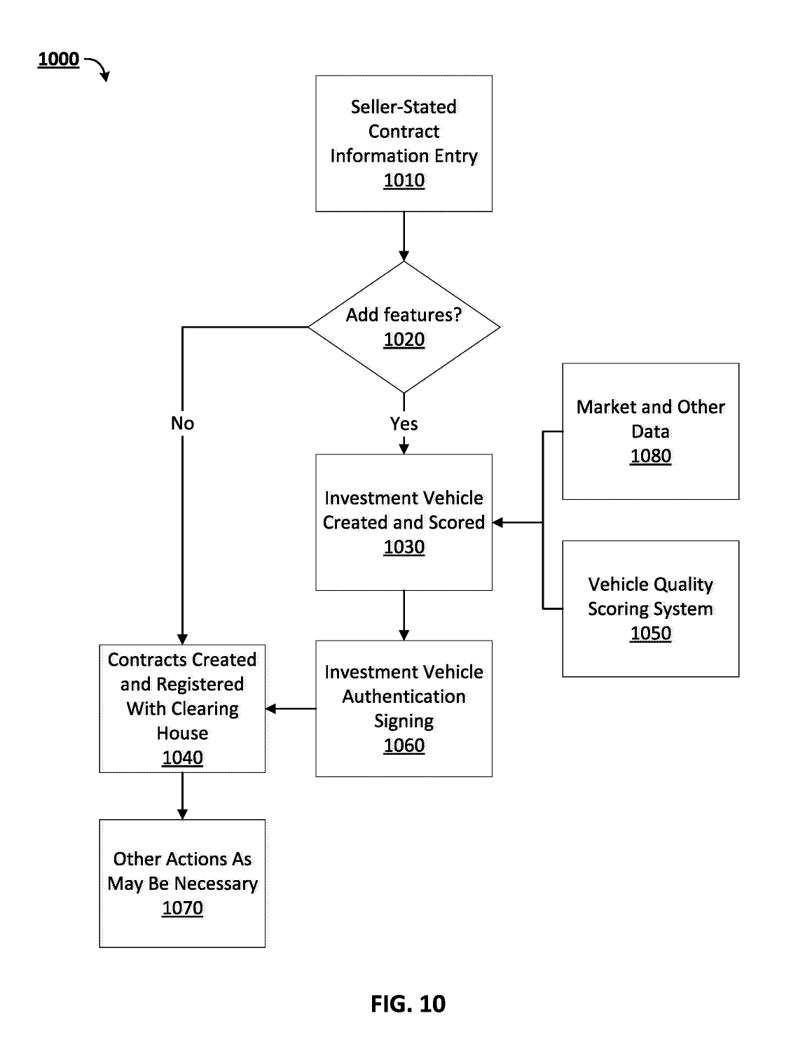

FIG. 10 depicts a process 1000 of using a seller-stated contract entry system, in accordance with some embodiments. This seller-stated system can be implemented, at least in part, by the platform 110 described herein. The process 1000 can provide an alternate method for contract creation wherein sellers state or otherwise enter contract data and any associated information into the system themselves or via any other intermediary such as a broker or exchange at 1010. Due to information asymmetry and uncertainty, seller-stated contracts may carry a low value in the marketplace. However, due to their flexibility and ease of creation, seller-stated contracts may be preferred. Sellers, at their discretion are able to access and apply various system capabilities to add features and options in the creation of investment instruments at 1020. These features may include legal rules validation, data validation, event tracking functionality, and other data integrity features as may be provided by a system similar to the contract rules system 220, and event management capabilities similar to those provided by the market management system 270, and/or may also include third-party certification of any information provided by the seller at 1010. After the seller selects the features and management options they desire at 1020, a seller-stated instrument is created and may be assigned a score or other value to indicate the degree of data validation the contract has passed prior to its creation at 1030. This score may be provided by a third party rating agency, a proprietary scoring system, industry best practices, or other methods at 1050. The authenticity of the performed data validation and other information that may be attached to the investment vehicle which is created may be presented in a way such that the source of the information, representations, and other features of the contract can be authenticated at 1060. Some examples of this form of authentication may include the use of digital certificates or digital signatures, or other such identity and authentication technology as may be practical to provide for assurance as to the source of the information, validations, and so forth, as may be contained in or otherwise associated with the investment vehicle (e.g., the contract). Once the investment vehicle is completed, the seller may derive a number of contracts from it and register those contracts with the clearinghouse at 1040. The seller-stated contract is then made available in the market place. Additionally or alternatively, the seller may simply create the contract with no features and offer it for sale in the marketplace, bypassing the instrument creation and scoring at 1030, and authentication at 1060.

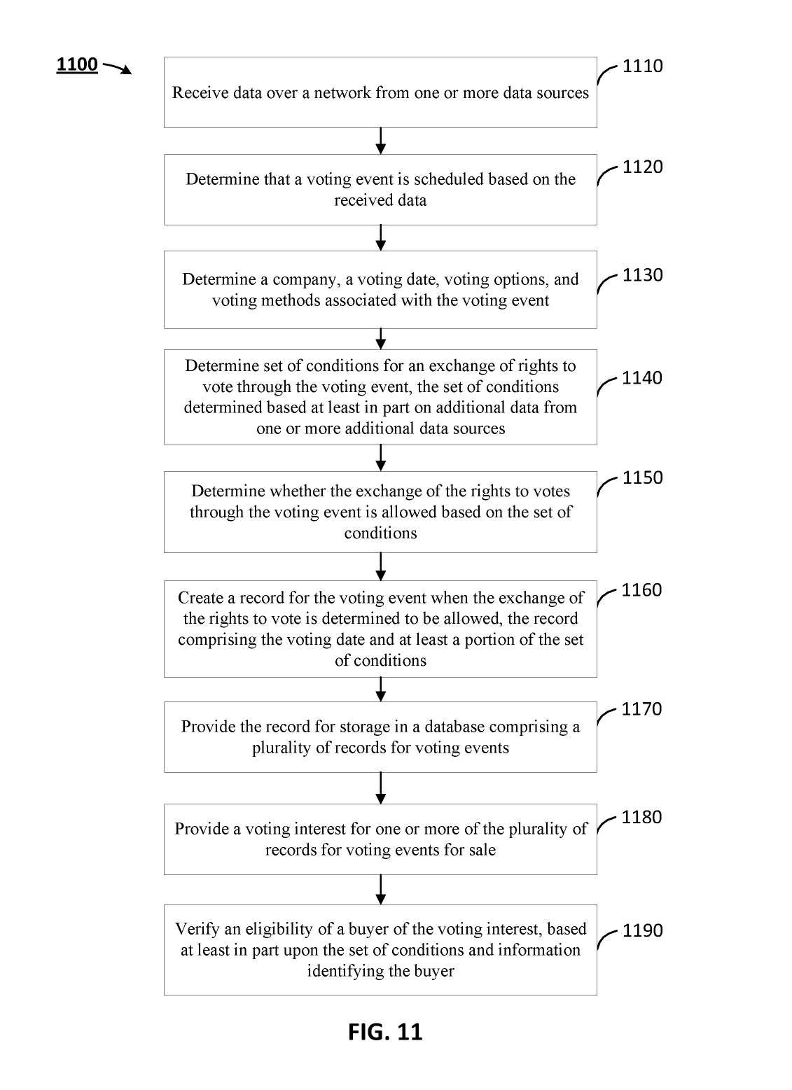

FIG. 11 illustrates a process 1100 for generating an investment instrument. In various embodiments, the process 1100 may be implemented by one or more of the components of the platform 110 described herein. Although illustrated as occurring in a particular order, one or more of the operations of the process 1100 may occur in a different order, one or more of the operations may not occur, and/or additional operations not depicted may occur. Thus, each of the operations of the process 1100 may be viewed as optional.

As illustrated, process 1100 can start at 1110 where the platform 110, for example, receives data over a network from one or more data sources. In various embodiments, the computing device comprises a server, and the one or more data sources comprise one or more content production sources.

Next, at operational block 1120 the platform 110, for example, determines that a voting event is scheduled based on the received data.

Next, at operational block 1130 the platform 110, for example, determines a company, a voting date, voting options, and voting methods associated with the voting event. In some aspects, the voting methods may refer to methods by which a vote may validly be placed for the voting event (e.g., via mail).

Next, at operational block 1140 the platform 110, for example, determines a set of conditions for an exchange of rights to vote through the voting event, the set of conditions determined based at least in part on additional data from one or more additional data sources. In some embodiments, the set of conditions comprises at least one of legal rules, broker rules, exchange rules, escrow rules, underwriting rules, and/or other rules.

Next, at operational block 1150 the platform 110, for example, determines whether the exchange of the rights to votes through the voting event is allowed based on the set of conditions.

Next, at operational block 1160 the platform 110, for example, creates a record for the voting event when the exchange of the rights to vote is determined to be allowed, the record comprising the voting date and at least a portion of the set of conditions.

Next, at operational block 1170 the platform 110, for example, provides the record for storage in a database comprising a plurality of records for voting events. In some aspects, additional information is stored as part of the record, such as information about the company, the voting options, the voting methods, and/or the like. In various embodiments, the plurality of records for the voting events comprise one or more table structures stored in the database. In some aspects, at least a portion of the stored data may be substantially unstructured. In various embodiments, the method 1100 may additionally or alternatively include monitoring, by the computing device, a data feed from a plurality of legal proceeding sources; automatically detecting, by the computing device, that a change of law regarding the exchange of the rights to vote has occurred based on the data feed; and/or updating, by the computing device, the set of conditions based on the change of law detected. In similar embodiments, other sources of information may be monitored, such as sources from which a change in interests rates for particular contracts may be determined.

In various embodiments, the method 1100 may additionally or alternatively include comparing, at the computing device, the voting event against the plurality of stored records for the voting events to determine whether the voting event is new; determining, when the voting event is not new, whether a stored date for the voting event has changed based on the voting date; and/or updating, when the stored date has changed, the stored date to reflect the voting date. In similar embodiments, other information related to the voting event may be updated, such as the voting options, the voting methods, associated deadlines, and/or the like.

In some embodiments, the method 1100 may additionally or alternatively include marking, by the computing device, the record for the voting event as ineligible when it is determined that the exchange of the rights to votes through the voting event is not allowed; displaying, via a user interface, an indication that the voting event is not eligible for sale; and/or prohibiting, by the computing device, access to the record for exchange.

Next, at operational block 1180 the platform 110, for example, provides a voting interest for one or more of the plurality of records for voting events for sale.

Next, at operational block 1190 the platform 110, for example, verifies an eligibility of a buyer of the voting interest, based at least in part upon the set of conditions and information identifying the buyer. In some embodiments, the method 1100 may additionally or alternatively include receiving, at the computing device, one or more requests from a client device to verify whether a sale of the voting interest is valid, the one or more requests identifying the buyer and a seller of the voting interest.

In various embodiments, the method 1100 may additionally or alternatively include receiving, at the computing device, a request from a seller to sell the voting interest for one or more of the plurality of records for voting events for sale; verifying, at the computing device, an eligibility of the seller, based at least in part upon the set of conditions and information identifying the seller; and/or associating, by the computing device, the seller with a record for the requested voting interest, when the eligibility of the seller is verified

Without in any way limiting the scope, interpretation, or application of the claims appearing below, technical effects of one or more of the example embodiments disclosed herein are a reduction in voting fraud, an increase in shareholder voting participation, an ability for third party monitoring of voting history, and/or voting validation capability. For example, the ability to automatically verify the buyer and/or seller of a voting interest can insure that applicable laws are complied with during the exchange and/or the vote. Additionally, enabling the automatic verification of an exchange can make exchanges easier and more likely to occur, and thereby increasing the number of votes cast for a voting event.

Various embodiments of the subject matter described herein may be realized in digital electronic circuitry, integrated circuitry, specially designed ASICs (application specific integrated circuits), computer hardware, firmware, software, and/or combinations thereof. These various embodiments may include embodiment in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an embodiment of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet. As used herein, the term “module” refers to at least one hardware processor and at least one memory including code which when executed by the at least one hardware processor configures the module.

Although a few variations have been described in detail above, other modifications are possible. For example, while the descriptions of specific embodiments of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed is:

1. A system comprising:
at least one hardware data processor; and
at least one memory storing instructions which, when executed by the at least one hardware data processor, result in operations comprising:
receiving, at a computing device comprising the at least one hardware data processor, data over a network from one or more data sources;
determining, at the computing device, that a voting event is scheduled based on the received data;
determining, at the computing device, a company, a voting date, voting options, and voting methods associated with the voting event;
determining, at the computing device, a set of conditions for an exchange of rights to vote through the voting event, the set of conditions determined based at least in part on additional data from one or more additional data sources;
determining, at the computing device, whether the exchange of the rights to votes through the voting event is allowed based on the set of conditions;
creating, by the computing device, a record for the voting event when the exchange of the rights to vote is determined to be allowed, the record comprising the voting date and at least a portion of the set of conditions;
providing, by the computing device, the record for storage in a database comprising a plurality of records for voting events;
providing, by the computing device, a voting interest for one or more of the plurality of records for voting events for sale; and
verifying, at the computing device, an eligibility of a buyer of the voting interest, based at least in part upon the set of conditions and information identifying the buyer.

2. The system of claim 1, wherein the operations further comprise:
monitoring, by the computing device, a data feed from a plurality of legal proceeding sources;
automatically detecting, by the computing device, that a change of law regarding the exchange of the rights to vote has occurred based on the data feed; and
updating, by the computing device, the set of conditions based on the change of law detected.

3. The system of claim 1, wherein the operations further comprise:
marking, by the computing device, the record for the voting event as ineligible when it is determined that the exchange of the rights to votes through the voting event is not allowed;
displaying, via a user interface, an indication that the voting event is not eligible for sale; and
prohibiting, by the computing device, access to the record for exchange.

4. The system of claim 1, wherein the operations further comprise:
comparing, at the computing device, the voting event against the plurality of stored records for the voting events to determine whether the voting event is new;
determining, when the voting event is not new, whether a stored date for the voting event has changed based on the voting date; and
updating, when the stored date has changed, the stored date to reflect the voting date.

5. The system of claim 1, wherein the operations further comprise:
receiving, at the computing device, one or more requests from a client device to verify whether a sale of the voting interest is valid, the one or more requests identifying the buyer and a seller of the voting interest.

6. The system of claim 1, wherein the operations further comprise:
receiving, at the computing device, a request from a seller to sell the voting interest for one or more of the plurality of records for voting events for sale;
verifying, at the computing device, an eligibility of the seller, based at least in part upon the set of conditions and information identifying the seller; and
associating, by the computing device, the seller with a record for the requested voting interest, when the eligibility of the seller is verified.

7. The system of claim 1, wherein the set of conditions comprises at least one of legal rules, broker rules, exchange rules, escrow rules, and underwriting rules.

8. The system of claim 1, wherein the plurality of records for the voting events comprise one or more table structures stored in the database.

9. The system of claim 1, wherein the computing device comprises a server, and wherein the one or more data sources comprise one or more content production sources.

10. A non-transitory computer program product storing instructions which, when executed by at least one hardware data processors, result in operations comprising:
receiving, at a computing device, data over a network from one or more data sources;
determining, at the computing device, that a voting event is scheduled based on the received data;
determining, at the computing device, a company, a voting date, voting options, and voting methods associated with the voting event;
determining, at the computing device, a set of conditions for an exchange of rights to vote through the voting event, the set of conditions determined based at least in part on additional data from one or more additional data sources;
determining, at the computing device, whether the exchange of the rights to votes through the voting event is allowed based on the set of conditions;
creating, by the computing device, a record for the voting event when the exchange of the rights to vote is determined to be allowed, the record comprising the voting date and at least a portion of the set of conditions;
providing, by the computing device, the record for storage in a database comprising a plurality of records for voting events;
providing, by the computing device, a voting interest for one or more of the plurality of records for voting events for sale; and
verifying, at the computing device, an eligibility of a buyer of the voting interest, based at least in part upon the set of conditions and information identifying the buyer.

11. A method comprising:
receiving, at a computing device, data over a network from one or more data sources;
determining, at the computing device, that a voting event is scheduled based on the received data;
determining, at the computing device, a company, a voting date, voting options, and voting methods associated with the voting event;
determining, at the computing device, a set of conditions for an exchange of rights to vote through the voting event, the set of conditions determined based at least in part on additional data from one or more additional data sources;
determining, at the computing device, whether the exchange of the rights to votes through the voting event is allowed based on the set of conditions;
creating, by the computing device, a record for the voting event when the exchange of the rights to vote is determined to be allowed, the record comprising the voting date and at least a portion of the set of conditions;
providing, by the computing device, the record for storage in a database comprising a plurality of records for voting events;
providing, by the computing device, a voting interest for one or more of the plurality of records for voting events for sale; and
verifying, at the computing device, an eligibility of a buyer of the voting interest, based at least in part upon the set of conditions and information identifying the buyer.

12. The method of claim 11, further comprising:
monitoring, by the computing device, a data feed from a plurality of legal proceeding sources;
automatically detecting, by the computing device, that a change of law regarding the exchange of the rights to vote has occurred based on the data feed; and
updating, by the computing device, the set of conditions based on the change of law detected.

13. The method of claim 11, further comprising:
marking, by the computing device, the record for the voting event as ineligible when it is determined that the exchange of the rights to votes through the voting event is not allowed;
displaying, via a user interface, an indication that the voting event is not eligible for sale; and
prohibiting, by the computing device, access to the record for exchange.

14. The method of claim 11, further comprising:
comparing, at the computing device, the voting event against the plurality of stored records for the voting events to determine whether the voting event is new;
determining, when the voting event is not new, whether a stored date for the voting event has changed based on the voting date; and
updating, when the stored date has changed, the stored date to reflect the voting date.

15. The method of claim 11, further comprising:
receiving, at the computing device, one or more requests from a client device to verify whether a sale of the voting interest is valid, the one or more requests identifying the buyer and a seller of the voting interest.

16. The method of claim 11, further comprising:
receiving, at the computing device, a request from a seller to sell the voting interest for one or more of the plurality of records for voting events for sale;
verifying, at the computing device, an eligibility of the seller, based at least in part upon the set of conditions and information identifying the seller; and
associating, by the computing device, the seller with a record for the requested voting interest, when the eligibility of the seller is verified.

17. The method of claim 11, wherein the set of conditions comprises at least one of legal rules, broker rules, exchange rules, escrow rules, and underwriting rules.

18. The method of claim 11, wherein the plurality of records for the voting events comprise one or more table structures stored in the database.

19. The method of claim 11, wherein the computing device comprises a server, and wherein the one or more data sources comprise one or more content production sources.
